(19) United States
(12) Patent Application Publication
(10) Pub. No.: US 2026/0149719 A1
(43) Pub. Date: May 28, 2026

(54) SYSTEM AND METHOD FOR LIMITING PARTICIPATION IN AN ELECTRONIC COLLABORATIVE ENVIRONMENT

(71) Applicant: RingCentral, Inc., Belmont, CA (US)

(72) Inventors: Maxim Viktorovich Mikhailov, Funchal (PT); Vlad Vendrow, Reno, NV (US)

(21) Appl. No.: 19/414,869

(22) Filed: Dec. 10, 2025

(30) Foreign Application Priority Data
Mar. 29, 2024 (WO) PCT/RU2024/000106

(51) Int. Cl. H04L 9/40

(52) U.S. Cl. CPC H04L 63/104

(57) ABSTRACT

A computer-implemented method for limiting participation in an electronic collaborative platform includes providing a new participant access to a group participating within the electronic collaborative platform. The method also includes receiving a participation time corresponding to an amount of time that the new participant is permitted to participate in the group. Additionally, the method includes terminating the access of the new participant to the group upon expiration of the participation time.

### RELATED APPLICATIONS

The instant application claims the benefit and priority to the PCT application PCT/RU2024/000106, filed on Mar. 29, 2024, which is incorporated herein by reference in its entirety.

### BACKGROUND

Recent advancements in technology and in particular online technology have led to an increased use of online forums for collaboration purposes. For example, many employees are now working at least partially from home and attend online meetings and collaborate online. In one nonlimiting example, a user of a chat communication service may create an online chat group/team for conducting online collaboration environment (e.g., chat, share files, share audio/video, etc.) with other team members. Often times when a user is added to a group/team, the added user will have similar access as other users until the added user is removed or leaves the group/team.

A user that may be external to the group or external to an organization (hereinafter external user) may be needed for their expertise in a particular area. As such it may be desirable to add the external user to the group/team of the online collaborative environment. Often time the expertise of a user external to the group/team or external to the organization is needed for a limited amount of time, e.g., 1 day, 1 week, duration of a project, etc. Unfortunately, the conventional online collaborative environments are incapable of limiting the amount of time that a user is added as part of the group/team, thereby placing the burden and the responsibility on other team members to remove the external user when the external user is no longer needed. Moreover, often time when an external user is added there are no mechanisms in place to limit the external user from accessing certain content, thereby potentially exposing the external user to inappropriate material/content (e.g., outside of scope, confidential, etc.).

Additionally, the subject matter and scope of conversation may change throughout the lifecycle of a project, rendering the expertise of an external user that was added moot. Unfortunately, there is no automated way to determine whether the subject matter and scope has changed enough to necessitate the removal of the external user, thereby places the burden on other team/group members to manually remove the external user when the expertise of the external user is no longer needed.

### SUMMARY

Accordingly, a need has arisen to add users, e.g., external user, to a group/team of an online collaborative environment for a limited time and period. As such, the external user may be automatically removed and/or having the external user's access to the content terminated within the online collaborative environment after the expiration of the time. Moreover, a need has arisen to limit the external user that has been added to certain content (e.g., content within a certain scope, content that is not outside of confidentiality with the external user, etc.). It is further desirable to automatically determine whether the scope and the subject matter that originally necessitated the external user to be added to the group/team has sufficiently changed to require the external user's access to be terminated and/or the external user to be removed from the group/team.

In some embodiments, a method for limiting participation in an electronic collaborative platform includes providing a new participant access to a group participating within the electronic collaborative platform. The method further includes receiving a participation time corresponding to an amount of time that the new participant is permitted to participate in the group. The method also includes terminating the access of the new participant to the group upon expiration of the participation time. In some optional embodiment, the method includes removing the new participant from the group in response to the expiration of participation time.

In some embodiments, the account, e.g., Microsoft Teams® account, RingCentral® account, Slack® account, Zoom® account, etc., for the new participant in the electronic collaborative platform remains active subsequent to terminating access of the new participant to the group. In some nonlimiting examples, the method further includes after providing the new participant access to the group and before the expiration of the participation time, hiding content exchanged (e.g., content exchanged prior to the providing the new participant access to the group) in the group from the new participant. In some embodiments, the method includes performing natural language processing (NLP) to determine whether a change in scope of content within the group has occurred between a time that the new participant has been provided access and a present time exceeds a certain threshold. In some nonlimiting examples, the method further includes terminating the access of the new participant to the group at the present time before the expiration of the participation time in response to determining that the change in scope of content within the group between the time that the new participant has been provided access and the present time exceeds the certain threshold. In yet some nonlimiting examples, the method includes removing the new participant from the group in response to determining that the scope of content within the group between the time that the new participant has been provided access and the present time exceeds the certain threshold.

It is appreciated that in some embodiments, the method includes determining whether new content that is being exchanged within the group after the new participant has been provided access to the group is within an acceptable scope for the new participant. The method may further include preventing the new participant from accessing the new content in response to determining that the new content is outside of the acceptable scope for the new participant. In some nonlimiting examples, the method includes visually blocking the new content when the new content is being rendered to the new participant if the new content is visual in response to determining that the new content is outside of the acceptable scope for the new participant. In some nonlimiting examples, the method includes preventing an audio portion of the new content from being rendered to the new participant if the new content is audio in response to determining that the new content is outside of the acceptable scope for the new participant.

According to one nonlimiting example, the method includes tracking participation by the new participant after the new participant has been provided access to the group and removing the new participant from the group, wherein the removing occurs before the expiration of participation time in response to determining that the participation of the new participant is below a certain threshold.

These and other features and aspects of the concepts described herein may be better understood with reference to the following drawings, description, and appended claims.

### BRIEF DESCRIPTION OF DRAWINGS

FIGS. 1A-1C is a diagram showing an example of an online collaborative environment where a user is added for a limited period of time to a group/team according to some embodiments.

FIGS. 2A-2B is a diagram showing an example of setting a time limit for an external user to be added to a group/team according to some embodiments.

FIG. 3A is a diagram showing an example of when an external user has been added and joins a group/team according to some embodiments.

FIG. 3B is a diagram showing an example of terminating an external user's access to a group/team at the expiration of the time limit according to some embodiments.

FIG. 3C is a diagram showing an example of when an external user is removed from a group/team at the expiration of the time limit according to some embodiments.

FIG. 4 shows a diagram showing an example of content accessible to an external user when the external user joins a group/team according to some embodiments.

FIG. 5 shows a diagram showing an example of prior content being blocked from an external user at the time of joining a group/team according to some embodiments.

FIG. 6 shows a diagram showing an example of outside of scope content being blocked from an external user after the external user joins a group/team according to some embodiments.

FIG. 7A shows a diagram showing an example of an external user's access being terminated when there is a change in scope of content according to some embodiments.

FIG. 7B shows a diagram showing an example of an external user being removed from a group/team when there is a change in scope of content according to some embodiments.

FIG. 8 is a flow chart illustrating an example of method flow for adding an external user for a limited time period in accordance with some embodiments.

FIG. 9 is a block diagram depicting an example of computer system suitable for adding an external user for a limited time period in accordance with some embodiments.

FIG. 10 is a relational node diagram depicting an example of a neural network for limiting participation time according to some embodiments.

### DETAILED DESCRIPTION

The example embodiments described herein are directed to a communication system. The communication system is configured to facilitate communication between online users. Communication may be through an online forum, e.g., online group, online team, webinar, chat team, etc. The communication system may also facilitate communication between users via telephony and/or video conferencing, etc.

The communication system such as online collaborative system provides an environment that is configured to facilitate data exchanges, e.g., audio data, video data, content data (e.g., PowerPoint®, Word®, PDF, etc.), messaging (e.g., instant messaging), etc., amongst users. It is appreciated that the term “user(s)” generally refers to participants of a communication session whether as host or invitee(s) or team member(s). It is also appreciated that the term “user” is used interchangeably with “member” or “participant” throughout the application.

A host or an administrator or any online user may create an online group/team using the communication system. For example, a user may create an online group or team via a chat function of the communication system or via a calendar associated with the online collaborative environment. As another example, a user may create an online group for a webinar using the communication system. It is appreciated that the term “group” or “team” has been used interchangeably throughout the application.

Once an online team has been created, one or more members of the team can share electronic data/content with other users (i.e. team members). For example, a team member (whether the host or another team member) may post content to share with other team members or users may engage in online communication, e.g., messaging, video chat, audio chat, etc. It is appreciated that the content may be shared sporadically, as needed, or in real time, e.g., in chat application, in video conferencing application, in audio application, etc.

It may be desirable to limit the amount of time that a user, e.g., external user to the group/team or external user to an organization, can have access to the group/team. For example, it may be desirable to allow an outside vendor to participate in a group/team that has been created online for a certain period, e.g., duration of a particular project, for a day, for a week, etc., as desired. It is desirable for the external user to be automatically removed and/or prevented from having access to the content within the online collaborative environment after the expiration of the time or for the external user to be automatically removed. It is appreciated that an external user used throughout this application refers to a user that is to be added for a limited time period because either the external user is outside of a particular group or organization or associated with a different project.

Moreover, it may be desirable to limit the external user that has been added to have access to certain content (e.g., content within a certain scope, content that is not outside of confidentiality with the external user, etc.). It is further desirable to automatically determine whether the scope and the subject matter that originally necessitated the external user to be added to the group/team has sufficiently changed (e.g., through the course of online collaboration) to require the external user's access to be terminated and/or the external user to be removed from the group/team.

It is appreciated that Machine Learning (ML) and Artificial Intelligence (AI) may be used by the online collaborative system to identify external users to be added to a group/team, to limit the external user access to a group/team to a certain amount of time, to determine whether the content of online collaborative environment has changed in scope, to determine whether the external user's access to the group/team needs to be terminated prior to the expiration of time and/or whether the external user needs to be removed from the group/team prior to the expiration of time, etc. For example, various clustering (e.g. organizational relationship of a member to the host and/or external user, relevance of the content in an online collaborative environment to an external user and external user's background and prior interactions in other online groups, natural language processing (NLP) identifying the external user, prior behavior of the users, correlation between the title of the online group and users'backgrounds in comparison to that of the external user, correlation between the content being shared and the background of the users as well as the background of the external user, etc.) or pattern recognition algorithms for ML can be used to identify external user(s) to be added and/or the time limits that an external user to be added for. Moreover, various clustering (e.g. organizational relationship of a member to the host and/or external user, relevance of the content in an online collaborative environment to an external user and external user's background and prior interactions in other online groups, natural language processing (NLP) identifying the external user, prior behavior of the users and/or the external user, correlation between the title of the online group and users'backgrounds in comparison to that of the external user, correlation between the content being shared and the background of the users as well as the background of the external user, etc.) or pattern recognition algorithms for ML can be used to determine whether the content of online collaborative environment has changed in scope, to determine whether the external user's access to the group/team needs to be terminated prior to the expiration of time and/or whether the external user needs to be removed from the group/team prior to the expiration of time, etc. It is appreciated that ML algorithm may further be used to determine whether an external user is to be removed from the online group/team based on the external user's engagement and/or activity level. It is appreciated that the ML algorithm may be supervised or unsupervised.

It is appreciated that a neural network may use an input layer, one or more hidden layers, and an output layer to train the ML algorithm to identify an external user to be added, the amount of time that the external user is to be added for, terminating external user's access or removal from the group/team once the time limit expires or before the time expires if the scope of the subject matter in the online collaborative environment changes and exceeds a certain threshold or if the content is determined to be inappropriate for the external user (e.g., confidential, personal in nature, etc.). In some nonlimiting examples, supervised learning may be used for circumstances where the output is known or confirmed (e.g., external user known, the amount of time to limit the external user is known, the change in scope or inappropriate content is known, etc.). For supervised learning, known input data may be used to gradually adjust the model to more accurately compute the already known output. Once the model is trained, field data is applied as input to the model and a predicted output is generated.

In other embodiments, unstructured learning may be used when supervised learning is unavailable. Training of the neural network using one or more training input matrices, a weight matrix, and one or more known outputs is initiated by one or more computers associated with the online collaborative system, e.g., chat environment. In an embodiment, a server may run known input data through a deep neural network in an attempt to compute a particular known output. For example, a server uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server computer then re-computes another output from the deep neural network with the input training matrix and the adjusted weight matrix. This process continues until the computer output matches the corresponding known output. The server computer then repeats this process for each training input dataset until a fully trained model is generated.

In some embodiments, the input layer includes a plurality of training datasets that are stored as a plurality of training input matrices in a database associated with the communication system. The training input data includes, for example, organizational relationship of a member to the host, relevance of the shared content to a member's background and prior interactions in other online groups, prior behavior of the members, correlation between the title of the online group and members'backgrounds, correlation between the content being shared and the background of the members, level of engagement and/or activity, group members from different departments and their level of engagement and activity in other online groups, etc. Any type of input data can be used to train the model.

It is appreciated that the hidden layers represent various computational nodes that represent weighted relationships based on the weight matrix. It is appreciated that the weight of each line may be adjusted overtime as the model is trained. It is appreciated that any number of hidden layers may be used. The output layer may be the identification of external user, the amount of time that the external user is to have access to the group/team, whether the access of the external user should be terminated and/or the external user to be removed if the scope of the content in the online collaborative environment has changed that exceeds a certain threshold or if the content is inappropriate for the external user, etc., are known output. It is appreciated that in a structured model, the appropriate designation of external user, the amount of time to limit the external user, to terminate the external user's access to the group/team and/or remove the external user from the group/team if the scope of the content has changed and exceeds a certain threshold, etc., may be used as a target output for continuously adjusting the weighted relationships of the model. When the model successfully outputs the appropriate output, then the model has been trained and may be used to process live or field data.

Once the neural network is trained, the trained model will accept field data at the input layer. In some embodiments, the field data is live data that is accumulated in real time. In other embodiments, the field data may be current data that has been saved in an associated database. The trained model is applied to the field data in order to generate one or more appropriate output, e.g., identifying external user, determining an amount of time to limit the external user's access to a group/team, terminating external user's access to the group/team before the expiration of time if the scope of content within the online collaborative environment has changed and exceeds a certain threshold or if the content is inappropriate (e.g., confidential) for the external user, removing external user from the group/team before the expiration of time if the scope of content within the online collaborative environment has changed and exceeds a certain threshold or if the content is inappropriate (e.g., confidential) for the external user, etc.

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying,” “rendering,” “utilizing,” “launching,” “calling,” “starting,” “accessing,” “sending,” “conferencing,” “triggering,” “ending,” “suspending,” “terminating,” “monitoring,” “displaying,” “removing,” “performing,” “preventing,” “hiding,” “blocking,” “tracking,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

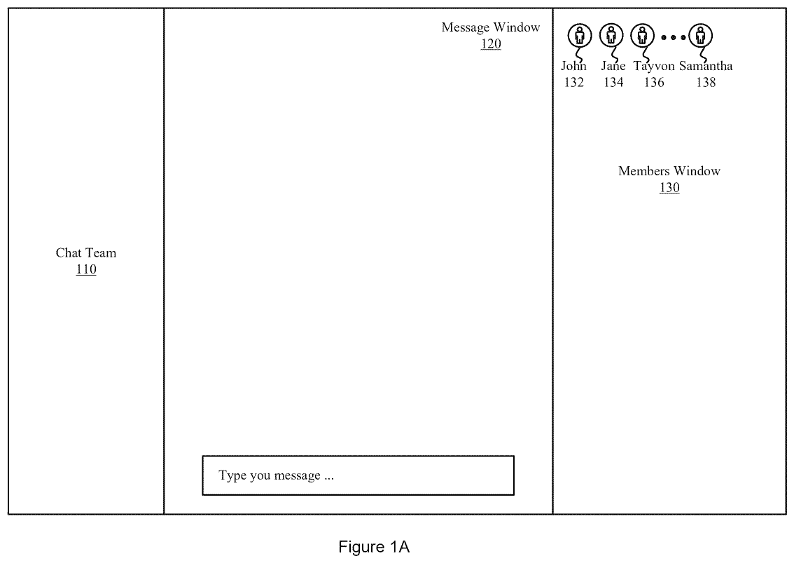

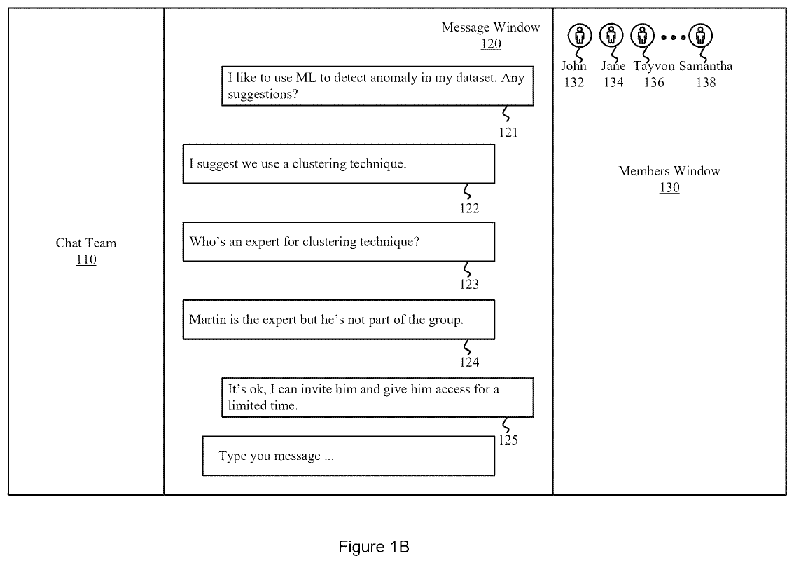

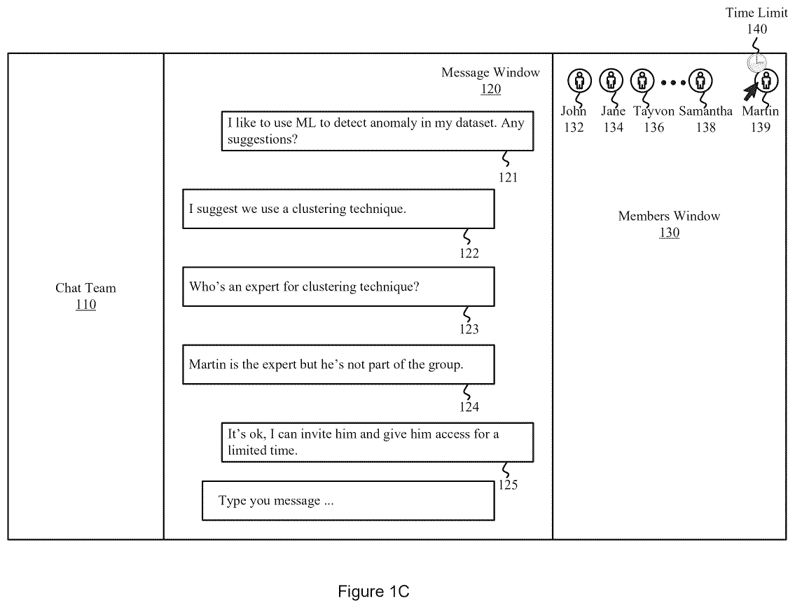

FIGS. 1A-1C is a diagram showing an example of an online collaborative environment where a user is added for a limited period of time to a group/team according to some embodiments. FIG. 1A shows an online collaborative environment where a chat team 110 has been created. The online collaborative environment may be a conferencing system that facilitates communication among different users of the group/team. The communication may facilitate a chat, a video conference, an audio call, a webinar, etc., among the team members. Accordingly, the group members may exchange data/content, e.g., audio data, video data, content data (e.g., PowerPoint®, Word®, PDF, etc.), messaging (e.g., instant messaging), etc.

A host or an administrator or any online user may create an online group/team using the online collaborative environment. For example, a host may enter a team title for chat team 110 within a graphical user interface (GUI). The host may select users within the group/team. In this nonlimiting example, the group/team includes users John 132, Jane 134, Tayvon 136, . . . , and Samantha 138 to form the online group/team. In some nonlimiting examples, a host may select the users 132, 134, 136, . . . 138 by instantiating a contact button to select the users from a rendered list. The selection may be based on the users being within a particular organization, team, project, etc. In yet some nonlimiting examples, the users may be selected automatically, e.g., using AI and ML by suggesting the members based on the description of the group/team. The online group/team may be a chat team or webinar or a team for videoconferencing as illustrative examples. Once the group/team is created the users within the group/team may exchange messages within the message window 120. It is appreciated that in addition to exchanging messages, e.g., chat messages, the users may also exchange video data, audio data, files, etc., with one another within the message window 120 or a separate window. In some nonlimiting example, the group/team that has been created may be given a name, e.g., Rockstar team. Additional information for the group/team that has been created may be added, e.g., description of the team, purpose of the team, time to meet (online), etc.

Regardless of the methodology that the users are selected, the group/team is created and once created the users may exchange electronic messages, e.g., chat messages, instant messages, email, etc., and content, e.g., video, audio, files, images, etc., among the users within the group/team. For example, referring now to FIG. 1B, user 132, John, may type a chat message 121 indicating that “I like to use ML to detect anomaly in my dataset. Any suggestions?” that is rendered within the message window 120 of a GUI. User 138, Samantha, may respond by typing a chat message 122 that “I suggest we use a clustering technique.” that is rendered within the message window 120 of a GUI. User 134, Jane, may respond by typing a chat message 123 that “Who's an expert for clustering technique?” that is rendered within the message window 120 of a GUI. User 136, Tayvon, may respond by typing a chat message 124 that “Martin is the expert but he's not part of the group” that is rendered within the message window 120 of a GUI. The user 132, John, may respond by typing a chat message 125 that “It's ok, I can invite him and give him access for a limited time.” that is rendered in the message window 120 of a GUI.

Referring now to FIG. 1C, a user within the group/team may add Martin 139 as an external user with a time limit 140 associated therewith. In one nonlimiting example, user 132, John, may instantiate a contacts button (not shown) to see a list of users and may select Martin 139 to be added to the group/team that users 132, 134, 136, . . . , 138 belong to, for a limited amount of time. It is appreciated that in one nonlimiting example, the external user may be suggested and/or selected by applying an ML algorithm, as described above. In yet another nonlimiting example, the amount of time limit may be suggested and/or selected by applying an ML algorithm. It is appreciated that once a time limit is applied, access of the external user, e.g., Martin 139, to the group/team (e.g., Rockstar team) is terminated upon expiration of the time limit unless the time limit is edited or upon a triggering event that causes the external user's access to the group/team to be terminated before the expiration of the time limit (described later). In some nonlimiting examples, the time limit may start at some point in the future rather than instantly upon the external user being added. For example, a user that is adding the external user may indicate that the external user is to be added from tomorrow, a day from tomorrow, a week from now, etc. The time limit may be duration of time, e.g., 2 hours, duration of project pendency, etc., or a particular date, e.g., Mar. 15, 2025, upon which access of the external user to the group/team is to be terminated.

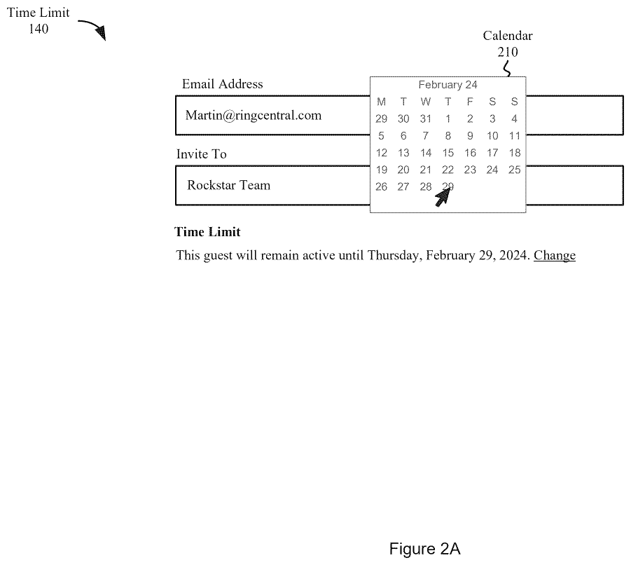

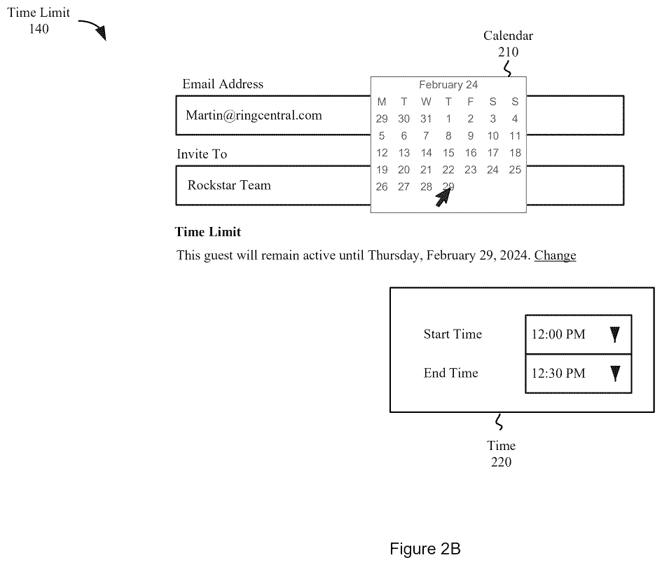

Referring now to FIGS. 2A-2B, a diagram shows an example of setting a time limit for an external user to be added to a group/team according to some embodiments. When the time limit 140 is instantiated, a window calendar 210 may be rendered to allow the user to select the date to start granting the external user access to the group/team and further to indicate a date to terminate the external user's access to the group/team. It is appreciated that in this nonlimiting example, the external user's access is selected to start immediately, e.g., Feb. 10, 2024, and to terminate automatically on Feb. 29, 2024. It is appreciated that the time limit 140 once selected may be edited and changed as long as the user making the change has the appropriate credentials, e.g., authority, to change the time limit 140. Referring now to FIG. 2B, a user may select a time 220 to be added to the date. For example, a user may choose to start at 2 pm on the start date and to terminate at 10 am on the termination date. In one nonlimiting example, a user may choose a time duration, e.g., 2 hours, 5 days, 3 weeks, 1 month, 1 year, etc. Once the date (e.g., starting date, ending date) and time (e.g., starting time, ending time, time period, etc.) are selected, then the external user, e.g., Martin 139, is added to the group/team and provided access to the group/team at the start date/time and the access is terminated on the termination date/time.

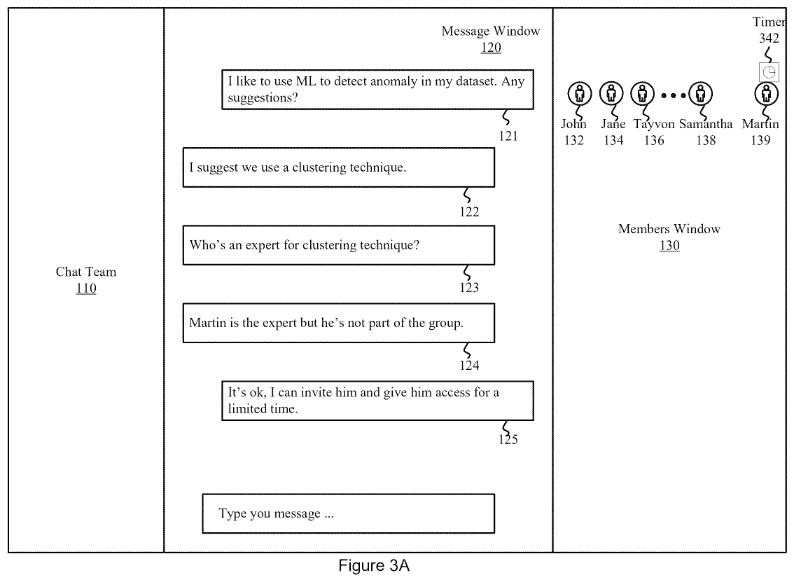

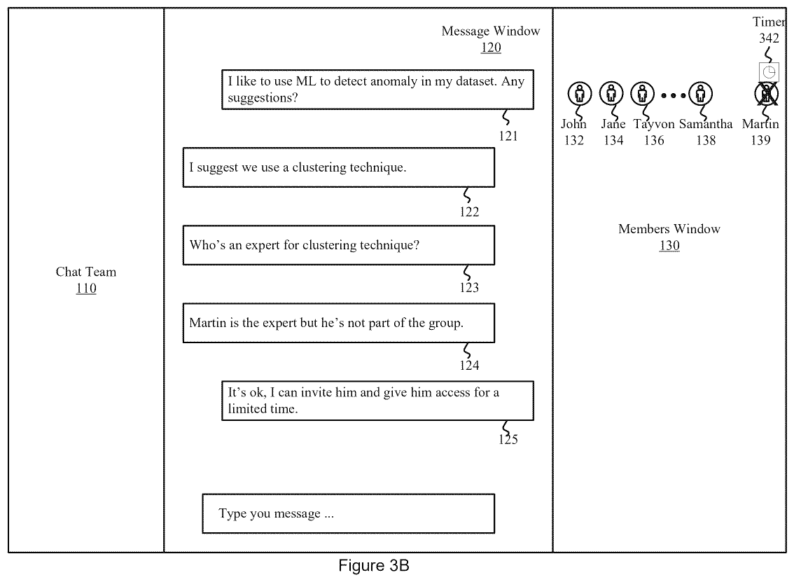

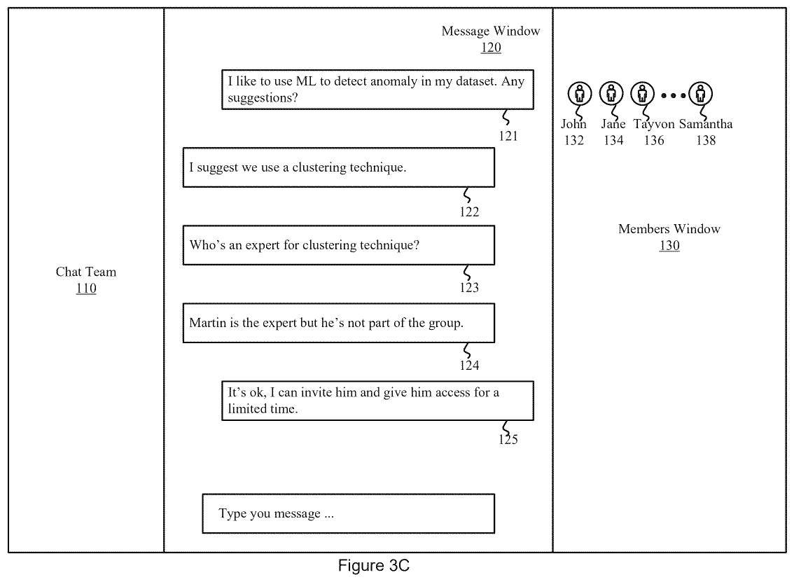

Referring now to FIG. 3A, an example of when an external user, e.g., user 139, has been added and joins a group/team, according to some embodiments. It is appreciated that in some nonlimiting examples, a timer 342 indicator may be displayed in close proximity to the external user 139 to illustrate that the external user 139 is a user within the group/team for a limited period of time. In one nonlimiting example, the timer 342 may display the amount of time remaining for the external user 139 before the access of the external user 139 is terminated and/or the external user 139 is removed from the group/team. In this nonlimiting example, the external user 139 may have access to all the previously exchanged communication, prior to the external user 139 receiving access to the group/team. For example, as illustrated the external user 139 may have access to previously exchanged chat messages, e.g., messages 121-125, between users 132, 134, 136, . . . , 138 that occurred prior to the external user 139 receiving access to the group/team. It is appreciated that the external user 139 may contribute and exchange content and messages with other users within the group/team once the external user 139 joins the group/team. It is appreciated that the embodiments are described with respect to messages being exchanged and the content being messages for illustration purposes but it should not be construed as limiting the scope of the embodiments. For example, the exchanged content may be audio, video, file, etc.

Referring now to FIG. 3B, an example of terminating an external user's access to a group/team at the expiration of the time limit according to some embodiments is shown. In this nonlimiting example, the time limit associated with the external user 139 has expired. As such, the access to the group/team by the external user 139 is terminated. In this nonlimiting example, the external user 139 may still remain part of the group/team but may no longer have access to the content exchanged or being exchanged between the users of the group/team after the expiration of the time limit. In some nonlimiting examples, the external user 139 may be removed from the group/team upon expiration of the time limit, as shown in FIG. 3C.

It is appreciated that while the access of the external user 139 may be terminated or the external user 139 may be removed from a given group/team, the external user 139 may still maintain his/her account associated with the online collaborative platform. For example, assuming that the online collaborative platform is a RingCentral® platform, then the external user 139 may maintain his account with RingCentral® and can use the platform to communicate with other users except for exchanging content or participating with the group/team that terminated the external user's 139 access, e.g., group/team for users 132, 134, 136, . . . , 138 where the external user 139 was added for a limited amount of time. Similarly, for Microsoft Teams the external user 139 may maintain the account for Microsoft Teams and may be able to communicate with users except for being prevented access to a particular group/team, e.g., group/team for users 132, 134, 136, . . . , 138 where the external user 139 was added for a limited amount of time.

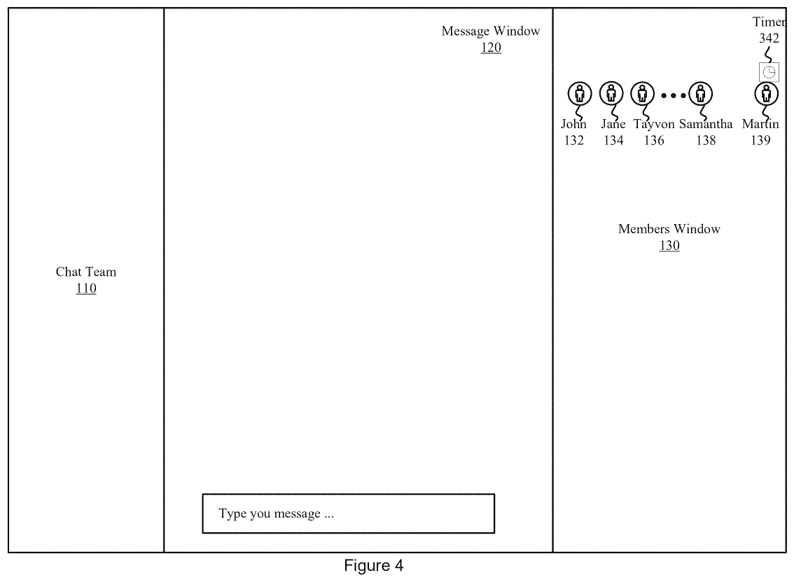

In one nonlimiting example, the external user 139 is given no access to the content exchanged between the users within the group/team that occurred before the external user 139 is given access, as shown in FIG. 4. As illustrated, all the prior messages, e.g., messages 121-125, are blocked from being accessed or seen by the external user 139. Similarly, other contents that were exchanged before the external user 139 joins a group/team for a limited time may be blocked from being seen by the external user 139. For example, audio, video, files, etc., exchanged among the users within the group/team before the external user 139 joins may be blocked from the external user 139.

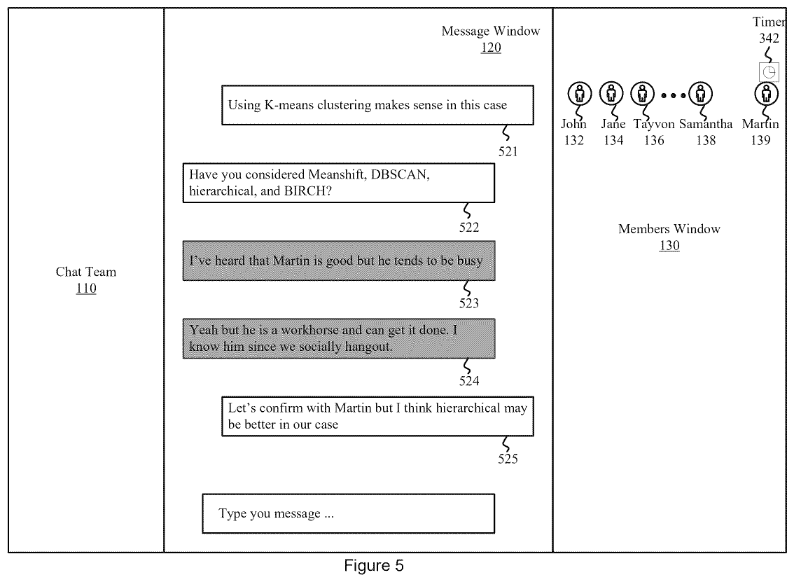

FIG. 5 shows a diagram showing an example of prior content being blocked from an external user at the time of joining a group/team according to some embodiments. In one nonlimiting example, some of the content exchanged between users 132, 134, 136, . . . 138 prior to the external user 139 been granted access to the group/team may be blocked from the external user 139 while other content is not blocked. As an example, ML may be applied to determine the reason why the external user 139 is being added, e.g., expertise in a certain subject matter such as ML and clustering. As such, certain content relevant to the expertise of the background of the external user 139 is rendered to the external user 139 while content that is determined not to be relevant is blocked from the external user 139.

In this nonlimiting example, certain messages were exchanged among the users 132, 134, 136, . . . , 138 prior to the external user 139 been granted access to the group/team. For example, user 132 may post a chat message 521 “using K-means clustering makes sense in this case.”, and user 136 may post a chat message 522 that “have you considered Meanshift, DBSAN, hierarchical, and BIRCH?”. User 134 may post a message 523 that “I've heard that Martin is good but he tends to be busy” and user 138 posts a message 524 that “Yeah but he is a workhorse and can get it done. I know him since we socially hangout.” User 132 may post message 525 that “Let's confirm with Martin but I think hierarchical may be better in our case”. In this nonlimiting example, since messages 523 and 524 are unrelated to the external user's 139 expertise or background, they may be blocked from the external user 139 when the external user 139 is added to the group/team or granted access. In contrast, messages 521-522, and 525 relate to the expertise of the external user 139 and background and is therefore rendered to the external user 139 once the user joins the group/team or granted access to the group/team. In other words, ML and/or natural language processing (NLP) may be performed on the content exchanged among the users within a group/team (prior to the external user 139 joining the group/team or given access) to determine suitability of that content to be rendered to the external user 139 once the external user 139 is granted access to the group/team. It is appreciated that the messages 523 and 524 may be redacted, blurred, blocked, etc., to prevent the external user 139 from seeing it. It is further appreciated that video content and/or audio content may similarly be blocked, as needed. It is appreciated that the suitability of the content to be rendered to the external user 139 may be based on a number of different factors, e.g., scope of external user's expertise, external user's background, reason why the external user 139 is being granted access to the group/team, scope of the content, confidentiality associated with content, private content (e.g., conversation) as opposed to work related content, appropriateness of the content (e.g., insult and profanity may be blocked), etc.

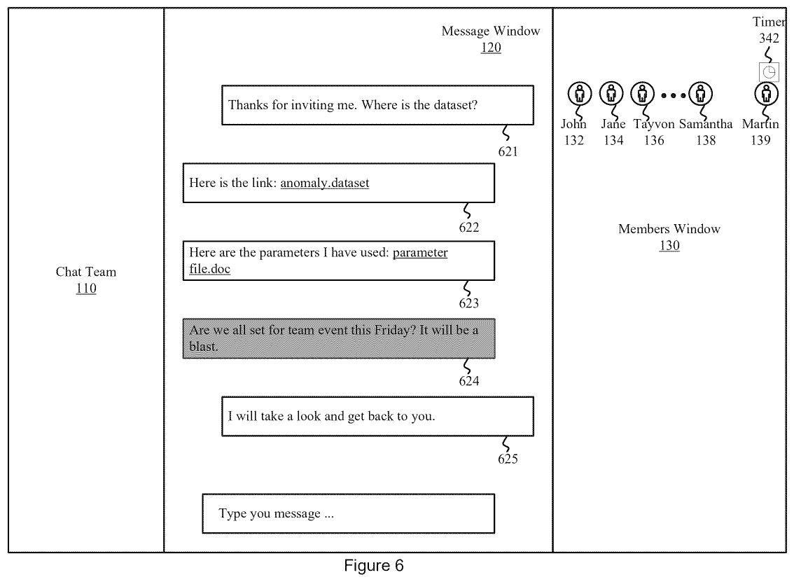

FIG. 6 shows a diagram showing an example of outside of scope content being blocked from an external user after the external user joins a group/team according to some embodiments. In this nonlimiting example, the external user 139 is added to the group/team or provided access and can contribute through the online collaborative platform. In this example, the external user 139 may post a message 621 “Thanks for inviting me. Where is the dataset?”. One of the users may post a message 622 “Here is the link: anomaly. dataset” while another may post a message 623 “Here are the parameters I have used: parameterfile.doc”. A user, e.g., Tayvon 136, may post a message 624 “Are we all set for team even this Friday? It will be a blast.” And the external user 139 may post a message 625 “I will take a look and get back to you.” In this nonlimiting example, ML may be applied to determine content that is outside of the scope for the external user 139. For example, a team event on a Friday and the event being a blast may be determined to be outside of the scope of the content, e.g., ML, clustering, etc., and the reason why the external user 139 has been added to the group/team or provided access. As such, message 624 may be blocked from being rendered to the external user 139. It is appreciated that the example above uses messages being posted for illustrative purposes but that should not be construed as limiting the scope of the embodiments. For example, a similar mechanism may be applied to other types of content being exchanged, e.g., video content, audio content, file, etc. For video content, certain frames or portion of a single frame may be blocked, blurred, redacted, blacked out, etc., to prevent the external user 139 from accessing content that is deemed to be unsuitable for the external user 139. Similarly, for audio content, certain audio segments may be beeped or muted to prevent the external user 139 from accessing content that is deemed to be unsuitable for the external user 139.

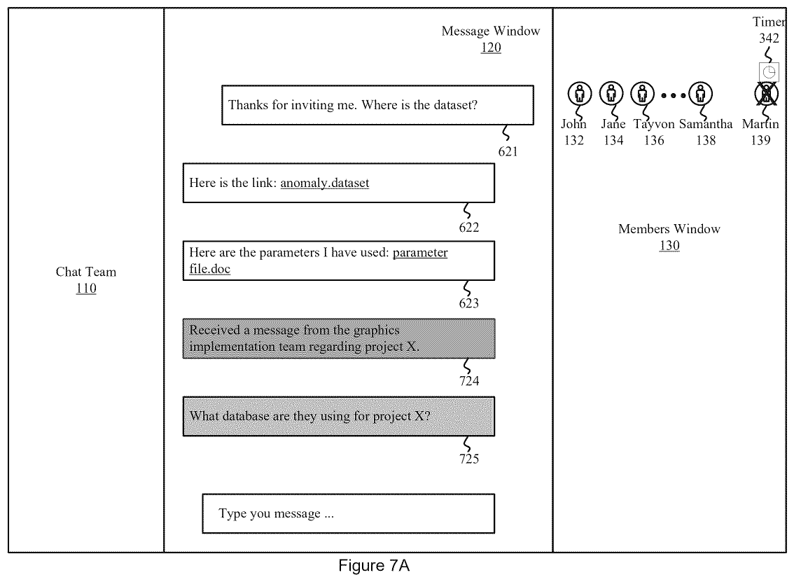

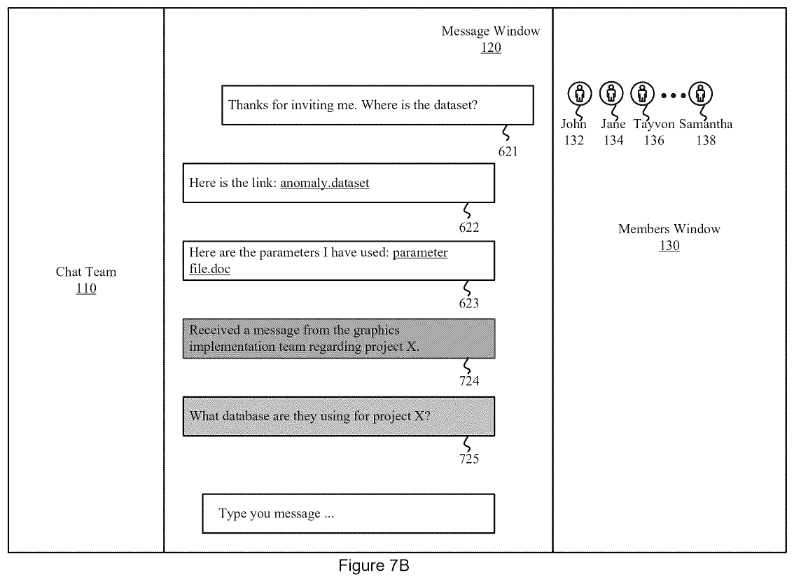

FIG. 7A shows a diagram showing an example of an external user's access being terminated when there is a change in scope of content according to some embodiments. In this nonlimiting example, the external user 139 has been added to the group/team or provided access. Messages 621-623 and 724-725 are exchanged. For example, the external user 139 may post a message 621 “Thanks for inviting me. Where is the dataset?” while other users may have responded in messages 622 and 623 that “Here is the link: anomaly.dataset” and “Here are the parameters I have used: parameterfile.doc”. However, at some point during collaboration, the discussions and the project may evolve to something that is determined to be outside of the scope for the external user 139. For example, subsequent messages 724 and 725 may contain “Received a message from the graphics implementation team regarding project X.” and “What database are they using for project X?”. ML application and/or NLP may determine that the scope of the content for the group/team that the external user 139 has been added or granted access has changed and exceeds a certain threshold. As such, ML and/or NLP may determine that the external user 139 access to the group/team while was appropriate at the time that the external user 139 was granted access or added to the group/team is no longer appropriate. As such, access for the external user 139 may be terminated even though the time limit has not expired. In other words, a triggering event has occurred that results in external user's 139 access being terminated prior to the expiration of the time.

In one nonlimiting example, the external user 139 may be removed from the group/team in response to the triggering event, as shown in FIG. 7B. It is appreciated that in some examples, the level of engagement by the external user 139 is tracked. The system may terminate external user's 139 access or remove the external user 139 from the group/team if it is determined that the level of engagement by the external user 139 is below a certain threshold level. Tracking engagement level of one or more users and adding/removing users based on their engagement levels is described in U.S. patent application Ser. No. 17/247,438 that was filed on Dec. 10, 2020, which is incorporated herein by reference in its entirety. It is appreciated that in one nonlimiting example, the activities and engagement of the external user 139 may be tracked for compensation purposes. For example, the amount of time that the external user 139 is active may be tracked and compensated at his/her hourly rate.

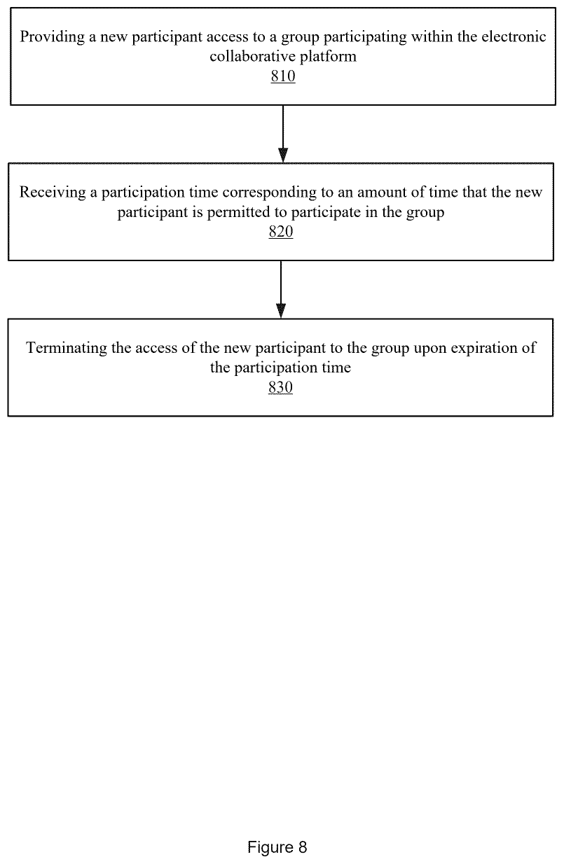

FIG. 8 is a flow chart illustrating an example of method flow for adding an external user for a limited time period in accordance with some embodiments. At step 810, a new participant is provided access to a group participating within the electronic collaborative platform. At step 820, a participation time corresponding to an amount of time that the new participant is permitted to participate in the group is received. In some embodiments, natural language processing (NLP) is performed to determine whether a change in scope of content has occurred within the group between a time that the new participant has been provided access and a present time exceeds a certain threshold. In some embodiments, after providing the new participant access to the group and before the expiration of the participation time, the content exchanged (e.g., content exchanged prior to the providing the new participant access to the group) in the group may be hidden from the new participant. At step 830, the access of the new participant to the group is terminated upon expiration of the participation time.

In some optional embodiments, the new participant is removed from the group in response to the expiration of participation time. In some embodiments, the account, e.g., Microsoft Teams® account, RingCentral® account, Slack® account, Zoom® account, etc., for the new participant in the electronic collaborative platform remains active subsequent to terminating access of the new participant to the group. According to some embodiments, it is determined whether new content that is being exchanged within the group after the new participant has been provided access to the group is within an acceptable scope for the new participant. According to some embodiments, the new participant is prevented from accessing the new content in response to determining that the new content is outside of the acceptable scope for the new participant. In some embodiments, the access of the new participant to the group is terminated at the present time before the expiration of the participation time. For example, the access may be terminated in response to determining that the change in scope of content within the group exceeds the certain threshold. In one nonlimiting example, determining whether the scope exceeds the certain threshold may occur between the time that the new participant has been provided access to the present time. In yet some nonlimiting examples, the new participant may be removed from the group in response to determining that the change in scope of content exceeds the certain threshold. In one nonlimiting example, the determination to that the scope of the content has exceeded the certain threshold may occur during the time that the new participant has been provided access and the present time. It is appreciated that in one nonlimiting example, the new content (e.g., visual content) may be visually blocked when the new content is being rendered to the new participant in response to determining that the new content is outside of the acceptable scope for the new participant. In some nonlimiting examples, an audio portion of the new content may be blocked from being rendered to the new participant in response to determining that the new content is outside of the acceptable scope for the new participant. In some nonlimiting examples, the participation by the new participant after the new participant has been provided access to the group is tracked. Accordingly, the new participant may be removed from the group before the expiration of participation time in response to determining that the participation of the new participant is below a certain threshold.

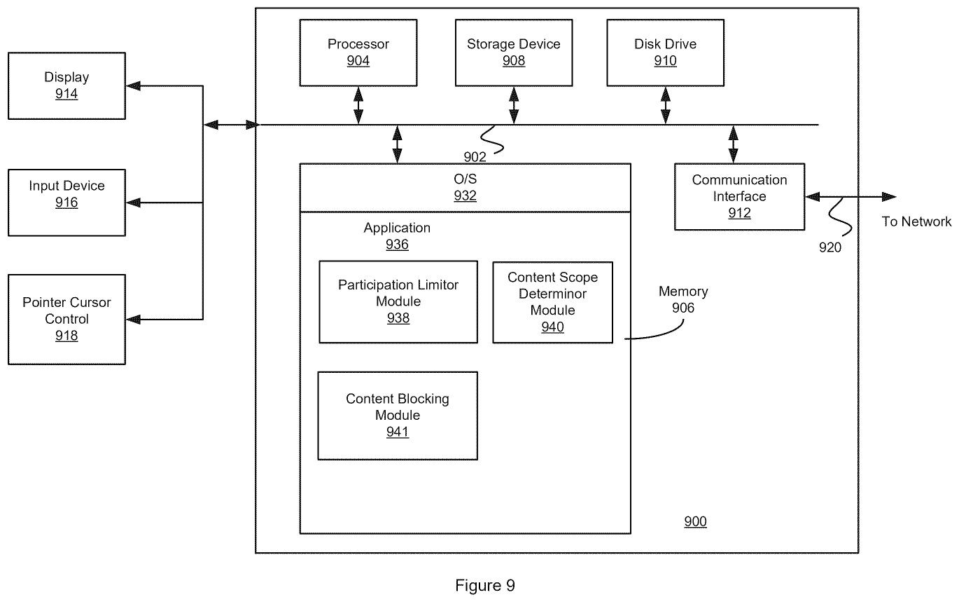

Referring now to FIG. 9, an exemplary block diagram of a computer system suitable for limiting participation in an electronic collaborative platform in accordance with some embodiments is shown. In some examples, computer system 900 can be used to implement computer programs, applications, methods, processes, or other software to perform the above-described techniques and to realize the structures described herein. Computer system 900 includes a bus 902 or other communication mechanism for communicating information, which interconnects subsystems and devices, such as a processor 904, a system memory (“memory”) 906, a storage device 908 (e.g., ROM), a disk drive 910 (e.g., magnetic or optical), a communication interface 912 (e.g., modem or Ethernet card), a display 914 (e.g., CRT or LCD), an input device 916 (e.g., keyboard), and a pointer cursor control 918 (e.g., mouse or trackball). In one embodiment, pointer cursor control 918 invokes one or more commands that, at least in part, modify the rules stored, for example in memory 906, to define the electronic message preview process.

According to some examples, computer system 900 performs specific operations in which processor 904 executes one or more sequences of one or more instructions stored in system memory 906. Such instructions can be read into system memory 906 from another computer readable medium, such as static storage device 908 or disk drive 910. In some examples, hard-wired circuitry can be used in place of or in combination with software instructions for implementation. In the example shown, system memory 906 includes modules of executable instructions for implementing an operating system (“OS”) 932, an application 936 (e.g., a host, server, web services-based, distributed (i.e., enterprise) application programming interface (“API”), program, procedure or others). Further, application 936 includes a module of executable instructions for participation limitor module 938 that limits the participation time associated with an external user, content blocking module 941 to determine suitability of content and blocking content that is not suitable for presentation to the external user, and content scope determinor module 940 to determine the scope of the content (or reason) associated with the external user that may be used by content blocking module 941 to determine whether the content is suitable for presentation to the external user.

The term “computer readable medium” refers, at least in one embodiment, to any medium that participates in providing instructions to processor 904 for execution. Such a medium can take many forms, including but not limited to, non-volatile media, volatile media, and transmission media. Non-volatile media includes, for example, optical or magnetic disks, such as disk drive 910. Volatile media includes dynamic memory, such as system memory 906. Transmission media includes coaxial cables, copper wire, and fiber optics, including wires that comprise bus 902. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 900. According to some examples, two or more computer systems 900 coupled by communication link 920 (e.g., LAN, PSTN, or wireless network) can perform the sequence of instructions in coordination with one another. Computer system 900 can transmit and receive messages, data, and instructions, including program code (i.e., application code) through communication link 920 and communication interface 912. Received program code can be executed by processor 904 as it is received, and/or stored in disk drive 910, or other non-volatile storage for later execution. In one embodiment, system 900 is implemented as a hand-held device. But in other embodiments, system 900 can be implemented as a personal computer (i.e., a desktop computer) or any other computing device. In at least one embodiment, any of the above-described delivery systems can be implemented as a single system 900 or can implemented in a distributed architecture including multiple systems 900.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Any of the above algorithms for limiting participation may be enhanced with machine learning. For example, the processor may be seeded with a learning library or construct a learning library on-the-fly which then allows the algorithm (and/or the library) to be updated each time it is used. Other machine learning approaches are also possible, for example, neural networks, Bayesian networks, deep learning, or the like. In some examples, the system may use machine learning to rank the limiting participation results. In further examples, the machine learning algorithm may incorporate input to limit participation results to the learning library.

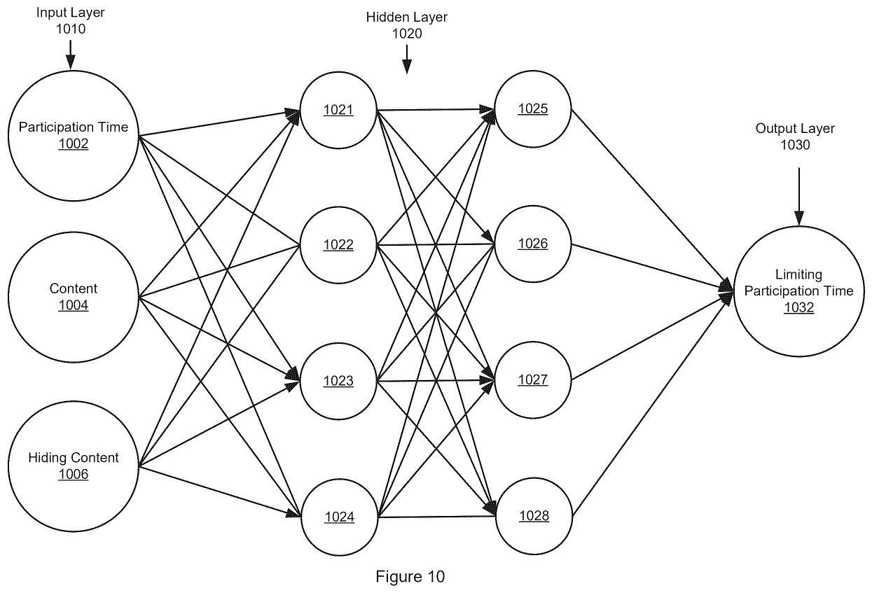

In an embodiment, machine learning may be used to limit participant access to content, limit participation time, terminate access, hide content, perform NLP, remove participant, determine whether new content is within an acceptable scope, prevent access to content, track participation, etc. Referring to FIG. 10, a neural network 1000 may utilize an input layer 1010, one or more hidden layers 1020, and an output layer 1030 to train a machine learning algorithm or model to limit participant access to content, to limit participation time, to terminate access, to hide content, to perform NLP, to remove participant, to determine whether new content is within an acceptable scope, to prevent access to content, to track participation, etc. In some embodiments, where participant access is limited, supervised learning is used such that known input data, a weighted matrix, and know output data is used to gradually adjust the model to accurately compute the already known output. In other embodiments, where limiting participant access is not identified, unstructured learning is used such that a model attempts to reconstruct known input data over time in order to learn.

Training of the neural network 1000 using one or more training input matrices, a weight matrix and one or more known outputs may be initiated by one or more external computers associated with the collaboration environment. For example, the neural network 1000 may be trained by one or more training computers and, once trained, used in association with the central server and/or user interface devices that are used to enabled one or more users to participate in the electronic collaborative platform and to limit participant access, as described above. In an embodiment, a computing device may run known input data through a deep neural network 1000 in an attempt to compute a particular known output. For example, a server computing device uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server then re-computes another output from the deep neural network with the input training matrix and the adjusted weight matrix. This process continues until the computer output matches the corresponding known output. The server then repeats this process for each training input dataset until a fully trained model is generated.

In the example of FIG. 10, the input layer 1010 includes a plurality of training datasets, e.g., participation time, content, hiding content, NLP, etc., that are stored as a plurality of training input matrices in an associated database. The training input data includes, for example, participation time 1002, content 1004, hiding content 1006, etc. FIG. 10 uses a single neural network for illustration purposes and should not be construed as limiting the scope of the embodiments. For example, any number of neural networks may be used to train the module.

In the embodiment of FIG. 10, hidden layers 1020 represent various computational nodes 1021, 1022, 1023, 1024, 1025, 1026, 1027, 1028. The lines between each node 1021, 1022, 1023, 1024, 1025, 1026, 1027, 1028 represent weighted relationships based on the weight matrix. As discussed above, the weight of each line is adjusted overtime as the model is trained. While the embodiment of FIG. 10 features two hidden layers 1020, the number of hidden layers is not intended to be limiting. For example, one hidden layer, three hidden layers, ten hidden layers, or any other number of hidden layers may be used for a standard or deep neural network. The example of FIG. 10 also features an output layer 1030 with limiting participation time 1032 as the known output. As discussed above, in this structured model, the limiting participation time 1032 is used as a target output for continuously adjusting the weighted relationships of the model. When the model successfully outputs the limiting participation time 1032, then the model has been trained and may be used to process live or field data.

Once the module is trained by the neural network 1000 of FIG. 10, the trained module will accept field data at the input layer 1010. In some embodiments, the field data is live data that is accumulated in real time. In other embodiments, the field data may be data that has been saved in an associated database. The trained module is applied to the field data in order to limit participation time at the output layer 1030. For instance, a trained module can determine whether to limit participation time, whether to limit access to content, whether to hide a content, etc.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A computer-implemented method for limiting participation in an electronic collaborative platform, the method comprising:
providing a new participant access to content of a group participating within the electronic collaborative platform;
receiving a participation time corresponding to an amount of time that the new participant is permitted to participate in the group; and
terminating the access of the new participant to the group upon expiration of the participation time.

2. The computer-implemented method as described in claim 1, wherein an account for the new participant in the electronic collaborative platform remains active subsequent to terminating access of the new participant to the group.

3. The computer-implemented method as described in claim 1, further comprising:
after providing the new participant access to the group and before the expiration of the participation time, hiding content exchanged in the group from the new participant, wherein the content was exchanged prior to the providing the new participant access to the group.

4. The computer-implemented method as described in claim 1, further comprising:
performing natural language processing (NLP) to determine whether a change in scope of content within the group has occurred between a time that the new participant has been provided access and a present time exceeds a certain threshold.

5. The computer-implemented method as described in claim 4, further comprising:
responsive to determining that the change in scope of content within the group between the time that the new participant has been provided access and the present time exceeds the certain threshold, terminating the access of the new participant to the group at the present time before the expiration of the participation time.

6. The computer-implemented method as described in claim 5 further comprising:
removing the new participant from the group in response to determining that the change in scope of content within the group between the time that the new participant has been provided access and the present time exceeds the certain threshold.

7. The computer-implemented method as described in claim 1 further comprising:
removing the new participant from the group in response to the expiration of participation time.

8. The computer-implemented method as described in claim 1, further comprising:
determining whether new content that is being exchanged within the group after the new participant has been provided access to the group is within an acceptable scope for the new participant; and
in response to determining that the new content is outside of the acceptable scope for the new participant, preventing the new participant from accessing the new content.

9. The computer-implemented method as described in claim 8, further comprising:
in response to determining that the new content is outside of the acceptable scope for the new participant, visually blocking the new content when the new content is being rendered to the new participant if the new content is visual; and
in response to determining that the new content is outside of the acceptable scope for the new participant, preventing an audio portion of the new content from being rendered to the new participant if the new content is audio.

10. The computer-implemented method as described in claim 1 further comprising:
tracking participation by the new participant after the new participant has been provided access to the group; and
in response to determining that the participation of the new participant is below a certain threshold, removing the new participant from the group, wherein the removing occurs before the expiration of participation time.

11. A system for limiting participation in an electronic collaborative platform, comprising:
a processor; and
a memory, storing a set of instructions, that when executed by the processor, causes:
provide a new participant access to a group participating within the electronic collaborative platform;
receive a participation time corresponding to an amount of time that the new participant is permitted to participate in the group; and
terminate the access of the new participant to the group upon expiration of the participation time.

12. The system as described in claim 11, wherein an account for the new participant in the electronic collaborative platform remains active subsequent to terminating access of the new participant to the group.

13. The system as described in claim 11, further comprising:
after providing the new participant access to the group and before the expiration of the participation time, hiding content exchanged in the group from the new participant, wherein the content exchanged prior to the providing the new participant access to the group.

14. The system as described in claim 11, further comprising:
performing natural language processing (NLP) to determine whether a change in scope of content within the group between a time that the new participant has been provided access and a present time exceeds a certain threshold.

15. The system as described in claim 14, further comprising:
responsive to determining that the change in scope of content within the group between the time that the new participant has been provided access and the present time exceeds the certain threshold, terminating the access of the new participant to the group at the present time before the expiration of the participation time.

16. The system as described in claim 15 further comprising:
removing the new participant from the group in response to determining that the change in scope of content within the group between the time that the new participant has been provided access and the present time exceeds the certain threshold.

17. The system as described in claim 11 further comprising:
removing the new participant from the group in response to the expiration of participation time.

18. The system as described in claim 11, further comprising:
determining whether new content that is being exchanged within the group after the new participant has been provided access to the group is within an acceptable scope for the new participant; and
in response to determining that the new content is outside of the acceptable scope for the new participant, preventing the new participant from accessing the new content.

19. The system as described in claim 18, further comprising:
in response to determining that the new content is outside of the acceptable scope for the new participant, visually blocking the new content when the new content is being rendered to the new participant if the new content is visual; and
in response to determining that the new content is outside of the acceptable scope for the new participant, preventing an audio portion of the new content from being rendered to the new participant if the new content is audio;
tracking participation by the new participant after the new participant has been provided access to the group; and
in response to determining that the participation of the new participant is below a certain threshold, removing the new participant from the group, wherein the removing occurs before the expiration of participation time.

20. A non-transitory, computer-readable medium storing a set of instructions that, when executed by a processor, cause:
providing a new participant access to a group participating within the electronic collaborative platform;
receiving a participation time corresponding to an amount of time that the new participant is permitted to participate in the group; and
terminating the access of the new participant to the group upon expiration of the participation time.
